(19) United States
(12) Patent Application Publication
(10) Pub. No.: US 2007/0038332 A1
(43) Pub. Date: Feb. 15, 2007

(54) Apparatus, method and computer program product for controlling behavior of robot

(75) Inventors: Fumio Ozaki, Kanagawa (JP); Tetsuo Hasegawa, Tokyo (JP); Hisashi Hayashi, Kanagawa (JP); Seiji Tokura, Kanagawa (JP); Yasuhiko Suzuki, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/497,336

(22) Filed: Aug. 2, 2006

(30) Foreign Application Priority Data
Aug. 10, 2005 (JP) 2005-232628

(51) Int. Cl. G06F 19/00

(52) U.S. Cl. 700/245

(57) ABSTRACT

A behavior control apparatus includes an external condition acquiring unit configured to acquire an external condition of a mobile robot; a goal generating unit configured to generate a goal to be achieved by executing a plan for multiple functions of the mobile robot, based on the external condition; a goal class generating unit configured to generate a goal class indicating whether the goal is a general goal to be achieved in the order of generation of the goal or a conditional goal to be achieved by an interruption as satisfying a preset executing condition; an executing order determining unit configured to determine an executing order of the plan based on the goal class; and a plan generating unit configured to generate the plan for achieving a goal sequence of the order of execution.

### CROSS-REFERENCE TO RELATED APPLICATIONS

This application is based upon and claims the benefit of priority from the prior Japanese Patent Application No. 2005-232628, filed on Aug. 10, 2005; the entire contents of which are incorporated herein by reference.

### BACKGROUND OF THE INVENTION

1. Field of the Invention

This invention relates to an apparatus, a method, and a computer program product for controlling the execution of plans regarding a mobile robot.

2. Description of the Related Art

For an autonomous robot, when executing a process according to a prescheduled action plan, for example, if there is an order of another process from a person, the autonomous robot needs to stop the process under execution and then execute the ordered process.

Furthermore, the autonomous robot constantly needs to observe an external event (such as a speech order, a sensor input including such as an image process, and an event from network household electric appliances), to make an appropriate plan corresponding to the event, and to accurately execute thereof.

So far, there are autonomous robots that can deal with these events. The processes of the events have a priority for execution, and the execution order is automatically decided using the priorities of the processes. (for example, see Japanese Patent Application Laid-Open No. 2004-216528).

In order for the autonomous robot to coexist with persons, the autonomous robot is further required to be able to correspond to the conditions at that time of various events occurring in a real world (such as a new order to the robot from a person and an event indicating the detection of an obstacle by a sensor).

The present invention has been achieved in order to solve the above problems. It is an object of this invention to provide a behavior control apparatus, which is capable of generating a plan appropriate for the condition and operating the action plan to execute the plan with the appropriate timing.

### SUMMARY OF THE INVENTION

According to one aspect of the present invention, a behavior control apparatus includes an external condition acquiring unit configured to acquire an external condition of a mobile robot; a goal generating unit configured to generate a goal to be achieved by executing a plan for multiple functions of the mobile robot, based on the external condition; a goal class generating unit configured to generate a goal class indicating whether the goal is a general goal to be achieved in the order of generation of the goal or a conditional goal to be achieved by an interruption as satisfying a preset executing condition; an executing order determining unit configured to determine an executing order of the plan based on the goal class; and a plan generating unit configured to generate the plan for achieving a goal sequence of the order of execution.

According to another aspect of the present invention, a behavior control method includes acquiring an external condition of a mobile robot; generating a goal to be achieved by executing a plan for multiple functions of the mobile robot, based on the external condition; generating a goal class indicating whether the goal is a general goal to be achieved in the order of generation of the goal or a conditional goal to be achieved by an interruption as satisfying a preset executing condition; generating the plan for achieving a goal sequence of the order of execution; and determining an executing order of the plan based on the goal class.

A computer program product according to still another aspect of the present invention causes a computer to perform the behavior control method according to the present invention.

### BRIEF DESCRIPTION OF THE DRAWINGS

FIG. 1A is a plan view of a mobile robot, and FIG. 1B is a side view of the mobile robot;

FIG. 2 is a system block diagram of a robot system;

FIG. 3 is a block diagram showing the entire structure of the mobile robot according to a first embodiment of the present invention;

FIG. 4 is a diagram explaining a relationship of a goal with a plan and action;

FIG. 5 is a block diagram showing the functional structure of an external world monitoring unit;

FIG. 6 is a diagram showing an external event table utilized in generating an external event by an external event generating unit;

FIG. 7 is a block diagram showing the functional structure of a behavior planning unit;

FIG. 8 is a diagram showing the data structure of a goal creating table;

FIG. 9 is a diagram showing an example of the data structure of the goal class generating table;

FIG. 10 is a diagram showing an example of the data structure of an executing plan cue;

FIG. 11 is a diagram showing an example of the data structure of a conditional plan buffer;

FIG. 12 is a flowchart showing an action plan process by the mobile robot;

FIG. 13 is a flowchart showing the detailed process at a goal creating process (Step S106) explained in FIG. 12;

FIG. 14 is a flowchart showing the detailed process at a general plan executing order determination process (Step S120) explained in FIG. 12;

FIGS. 15A, 15B and 15C are diagrams for explaining, in more detail, the general plan executing order determination process when a newly created general plan has the higher priority than the currently executing plan;

FIGS. 16A and 16B are diagrams for explaining the process when the general plan is newly created;

FIGS. 17A and 17B are diagrams for explaining the process when the currently executing plan is interrupted and the newly created general plan is executed;

FIG. 18 is a flowchart showing the detailed process at a conditional plan storing process (Step S140) explained in FIG. 12;

FIGS. 19A and 19B are diagrams for explaining the process when the executing condition of the conditional plan stored in the conditional plan buffer is satisfied;

FIGS. 20A and 20B are diagrams for explaining the process when executing the conditional plan stored in the conditional plan buffer prior to the plan already stored in the executing plan cue;

FIG. 21 is a diagram showing the hardware structure of the mobile robot according to the first embodiment;

FIG. 22 is a diagram for explaining a first modification; and

FIGS. 23A and 23B are diagrams for explaining a second modification.

### DETAILED DESCRIPTION OF THE INVENTION

Exemplary embodiments of a behavior control apparatus, a behavior control method, and a behavior control program according to the present invention will be explained below with reference to the drawings. The embodiments do not limit the scope of this invention.

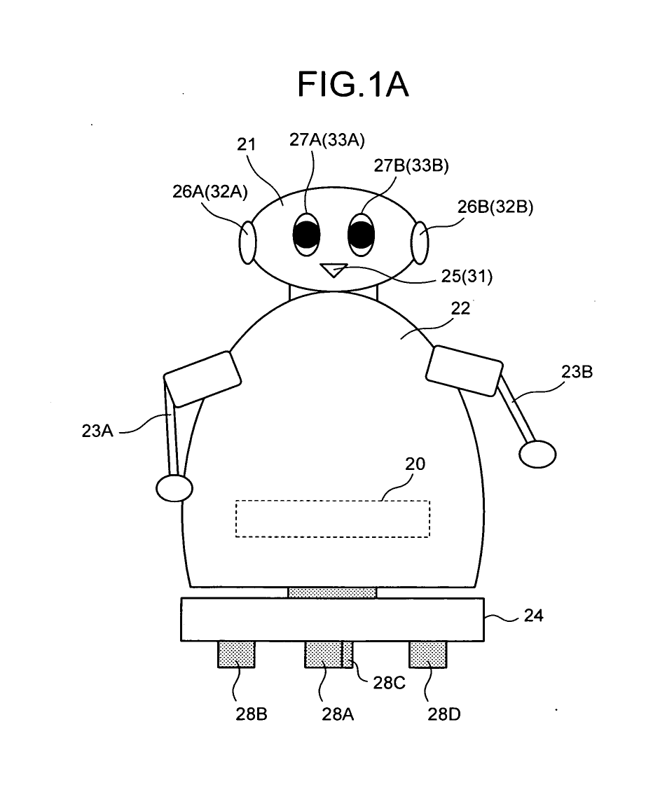

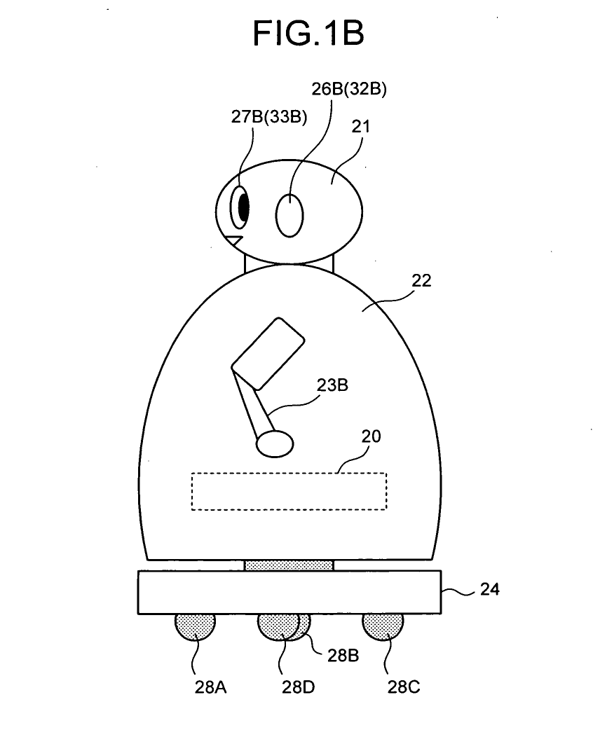

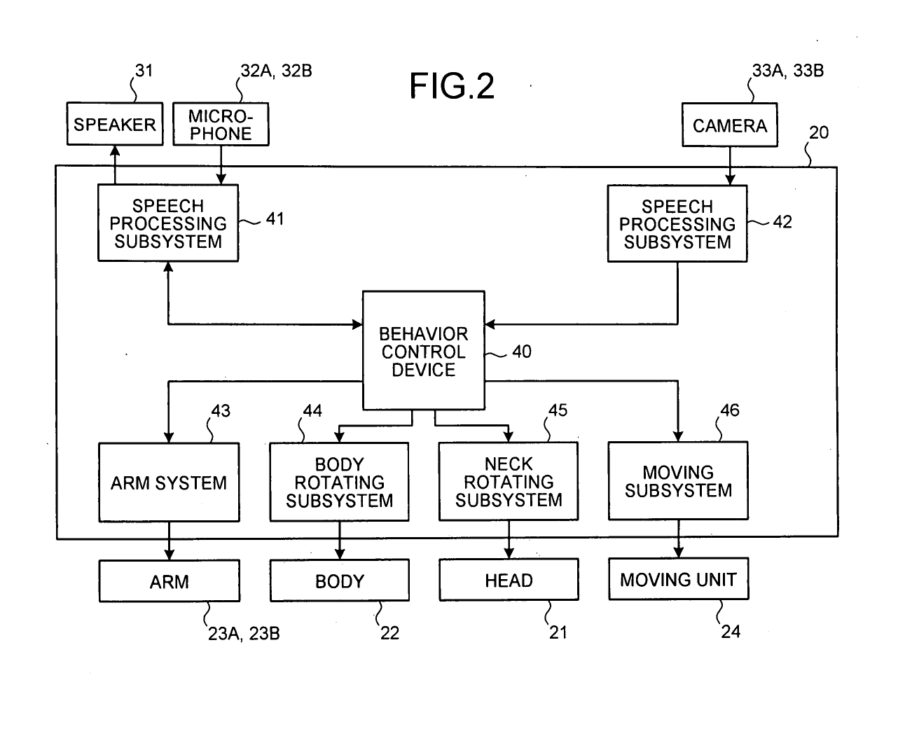

FIGS. 1A and 1B are diagrams showing an appearance structure of a mobile robot 1 with a built-in behavior control apparatus 40 (see FIG. 2) according to a first embodiment. FIG. 1A is a plan view of the mobile robot 1. FIG. 1B is a side view of the mobile robot 1.

The mobile robot 1 is shaped similar to that of a person, which is comprised of a head 21, a body 22, arms 23A and 23B, and a moving unit 24. The head 21 includes a mouth 25 having a speaker 31 which outputs speech, ears 26A and 26B having microphones 32A, 32B respectively which input speech, and two eyes 27A, 27B having cameras 33A, 33B respectively which input external images. The arms 23A, 23B have links, joints, and hands so as to simulate the movements of human arms, and hands.

The moving unit 24 has four wheels 28A, 28B, 28C, 28D, which enables the mobile robot 1 to move forward and backward or to change the direction to right and left on a floor surface, which are comparable to human legs.

The body 22 is a central portion of the mobile robot 1. The body 22 is connected to the head 21, the arms 23A and 23B, and the moving unit 24 through rolling mechanisms respectively and has a built-in robot control system 20, inside of the body 22, for performing the general control such as motions and information processing of the mobile robot 1.

FIG. 2 is a system block diagram of the robot system 20. The robot system 20 includes, the behavior control apparatus 40 for determining the motions and process of the mobile robot 1 itself and various subsystems 41 to 46 for inputting information for determining the motions and processing at the behavior control apparatus 40 (hereinafter, control input information) and for receiving to execute instruction information of the determined motions and process at the behavior control apparatus 40 (hereinafter, control output information).

A speech processing subsystem 41 performs general speech processing such as A/D conversion and D/A conversion, speech recognition, and speech synthesis, which supplies the control input information necessary for the behavior control apparatus 40 in external world speech input via the microphones 32A and 32B to the behavior control apparatus 40 and processes such as words generated inside of the behavior control apparatus 40 or the speech processing subsystem 41 through the speaker 31 for outputting the speech. Also, the speech processing subsystem 41, for example, may have a step of processing, when the input speech recognition is not satisfactory, to automatically output the speech by hearing again though the speech synthesis without going through the behavior control apparatus 40 (processing inside the speech processing subsystem 41 being closed).

The image processing subsystem 42 performs the image recognition of the image input from the cameras 33A and 33B, and supplies the control input information in the image-recognized information necessary for the behavior control apparatus 40 to the behavior control apparatus 40. Also, the image processing subsystem 42 has a step of processing distance measurement of an image target according to the triangulation method using the cameras 33A and 33B. Furthermore, the image processing subsystem 42 has a well known tracking function which, as continuously following the direction of the target image, continuously captures the target image.

An arm subsystem 43 receives the control information from the behavior control apparatus 40 and decides the physical driving amount of the respective joint of arm units 23A, 23B to move the arm units 23A, 23B. A body rotating subsystem 44 receives the control information from the behavior control apparatus 40 and decides the physical rotating amount of the body 22 relative to the moving unit 24 to rotate the body 22. A neck rotating subsystem 26 receives the control output information from the behavior control apparatus 40 and determines the physical rotating drive amount of the head 21 relative to the body 22 to rotate the head 21 of the neck. A moving subsystem 46 receives the control information from the behavior control apparatus 40 and determines the rotating amount of the respective wheels 28A to 28D to rotate the respective wheels 28A to 28D. Wheel speed may be adjusted by adjusting the rotating amount during a certain period of time.

The behavior control apparatus 40 determines the motion and process of the robot device itself and receives an external condition and internal condition (such as the posture of the robot device and the residual quantity of the battery) as the control input information, thereby, for example, determining one or more motions and processes and outputting the control information to one or more subsystem capable of performing the motions and processes according to a predetermined rule. Furthermore, the mobile robot 1 may have a clock system, a temperature sensor, and a humidity sensor, etc. The behavior control apparatus 40 may also control these sensors.

In addition, a static process such as calculation may be processed at the behavior control apparatus 40 without going through other subsystems.

Here, the mobile robot 1 according to the embodiment has the above-described subsystems 41 to 46; however, this invention is not limited thereto and for example, the mobile robot 1, when providing the mobile robot 1 which requires wireless function and display function, may have a wireless subsystem performing the wireless transmission process and a display subsystem, with an additional display device, performing the display control.

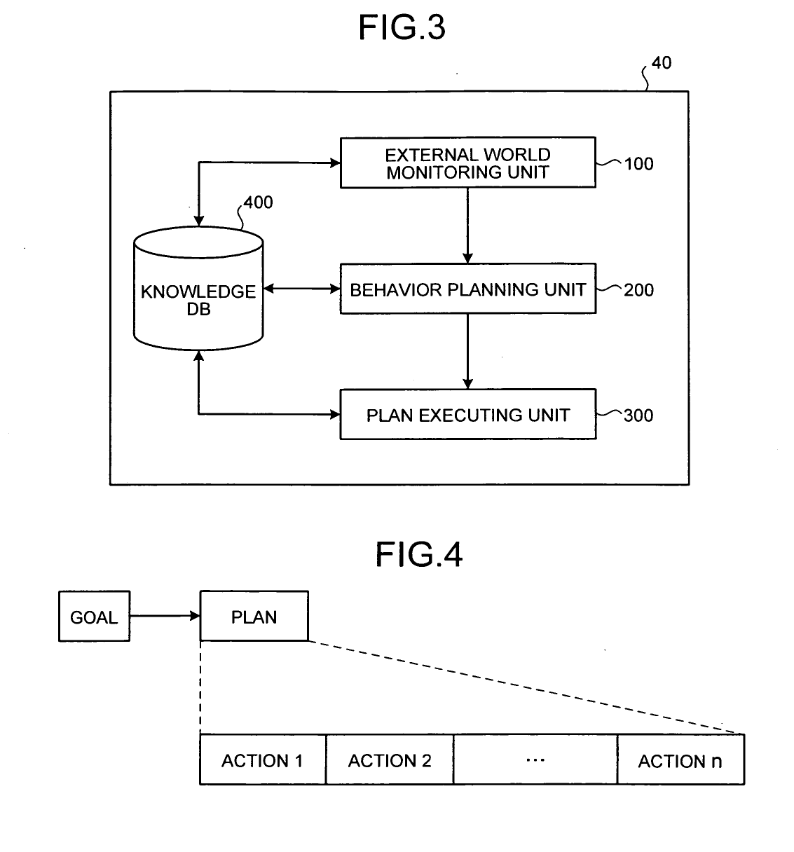

FIG. 3 is a block diagram showing the entire structure of the mobile robot 1 according to the embodiment of this invention. The mobile robot 1 has an external world monitoring unit 100, a behavior planning unit 200, a behavior plan executing unit 300, and a knowledge database (DB) 400.

The external world monitoring unit 100 monitors the external world and generates the external event from the monitoring result. Here, the external event can be such as a recognized oral command using the speech subsystem and a signal from the network devices. The external world monitoring unit 100 monitors the external events. For example, when the microphone 32A, 32B detect speech, it uses the result of the speech recognition of the speech detected to generate an event as an external event. Also, for example, if an obstacle is detected from a result of image recognition after the image pickup of cameras 33A and 33B, the result of detection indicating that the obstacle is detected may be generated as an external event. As such, the external world monitoring unit 100 treats the result of the detection such as by the sensors installed in the mobile robot 1 and the information acquired outside by the mobile robot 1 as the results of the external world monitoring in order to generate the external event based thereon.

The behavior planning unit 200 acquires the external event from the external world monitoring unit 100. Then, a goal is generated based on an external event. Here, a goal means a task to be executed and completed or a condition to be satisfied. Another example of the goal may be a target condition to be achieved.

The behavior planning unit 200 then creates a plan to achieve the goal. Here, the plan is a series of processes to execute and achieve the goal. The plan may have plural actions. Here, the action is a minimum unit for executing the plan.

The plan executing unit 300 executes a plan created at the behavior planning unit 200 per action. The details regarding the action will be explained later. The knowledge DB 400 holds various types of information. The external world monitoring unit 100, the behavior planning unit 200, and the plan executing unit 300 process with reference to the knowledge DB 400.

FIG. 4 is a diagram explaining the relationship of a goal of the behavior control apparatus 40 with a plan and actions. As shown in FIG. 4, the plan is generated based on the goal and the actions are generated based on the plan.

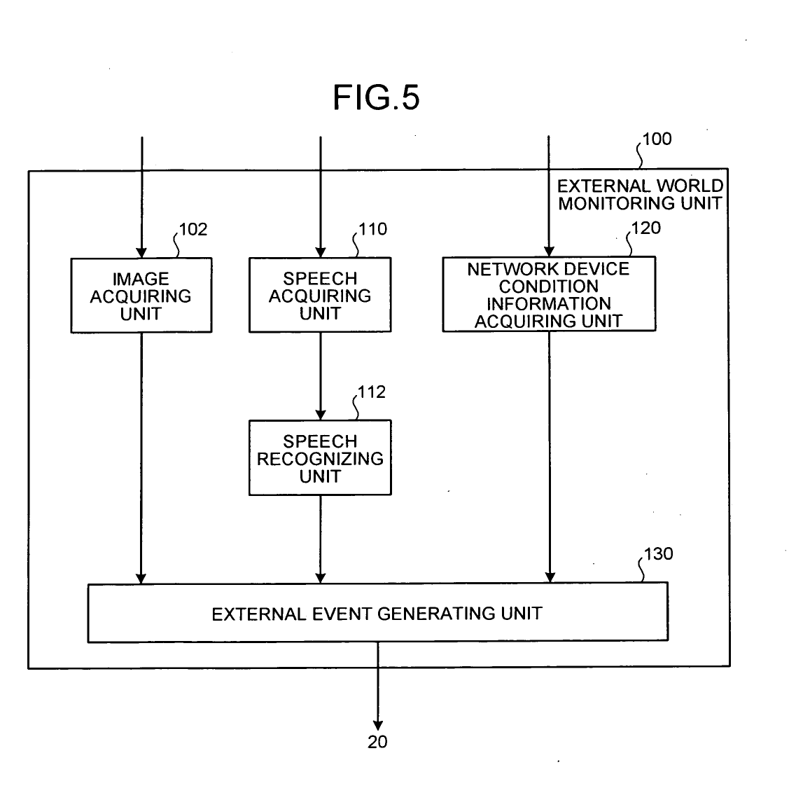

FIG. 5 is a block diagram showing the functional structure of an external world monitoring unit 100. The external world monitoring unit 100 comprises an image acquiring unit 102, a speech acquiring unit 110, a speech recognizing unit 112, a network device condition information acquiring unit 120, and an external event generating unit 130.

The image acquiring unit 102 acquires the detection result from the later described image sensor. The speech acquiring unit 110 acquires the speech acquired by the later described microphone. The speech recognizing unit 112 recognizes a speech acquired by the speech acquiring unit 110. The network device condition information acquiring unit 120 receives via network the network device condition information indicating the condition of other devices connected to the network.

The mobile robot 1 is connected to the network. Desired information may be acquired from other network devices connected to the network by UPnP (Universal Plug and Play). The network device condition information is the event information of the network devices to be acquired by UPnP.

The external event generating unit 130 generates an external event based on an image detection result acquired by the image acquiring unit 102, a speech recognition result acquired by the speech recognizing unit 112, and network device condition information acquired by the network device condition information acquiring unit 120.

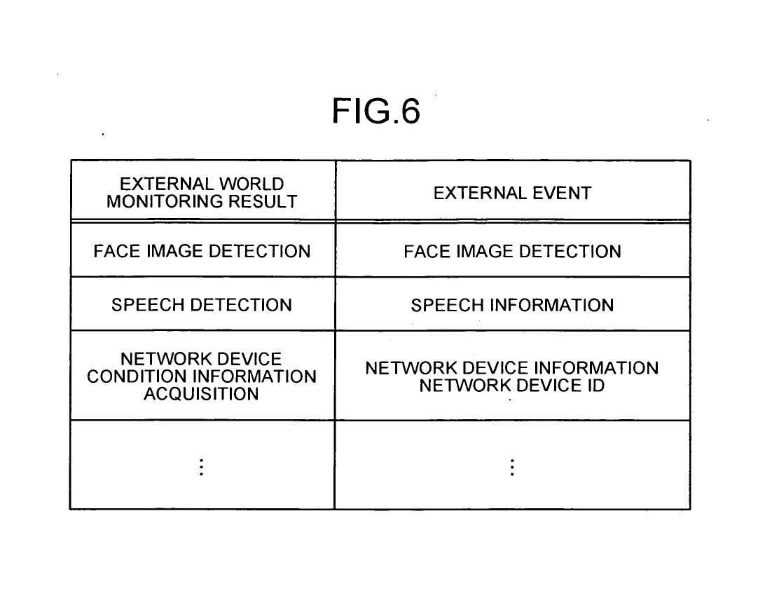

FIG. 6 is a diagram showing an external event table utilized in generating an external event by an external event generating unit 130. The external event table is held in the knowledge DB 400. In the external event table, an outside monitoring result and an external event acquired by the external event generating unit 130 are connected each other.

For example, when a face image is detected, the information indicating the detection of the face image is generated as an external event. Also, when a speech is detected to perform the speech recognition, the speech information acquired by the speech processing subsystem is generated as an external event.

Also, when a network device condition information is acquired from a network device, the acquired network device condition information and the information containing the network device ID identifying the network device are generated as an external event.

An external event is not being directly generated from either information. The corresponding external event is generated when the external world monitoring result stored in the external event table is acquired.

In the external event table according to this embodiment, one external event is generated from one external condition; however, this invention is not limited thereto and plural external events can be generated from one external condition. Also, if plural external conditions may be monitored and one external event may be generated.

Also, as another example, the knowledge DB 400 holds an algorithm instead of the external event table so as to generate an external event from a monitoring result. At this time, the external event generating unit 130 may generate an external event by using the algorithm held at the knowledge DB 400.

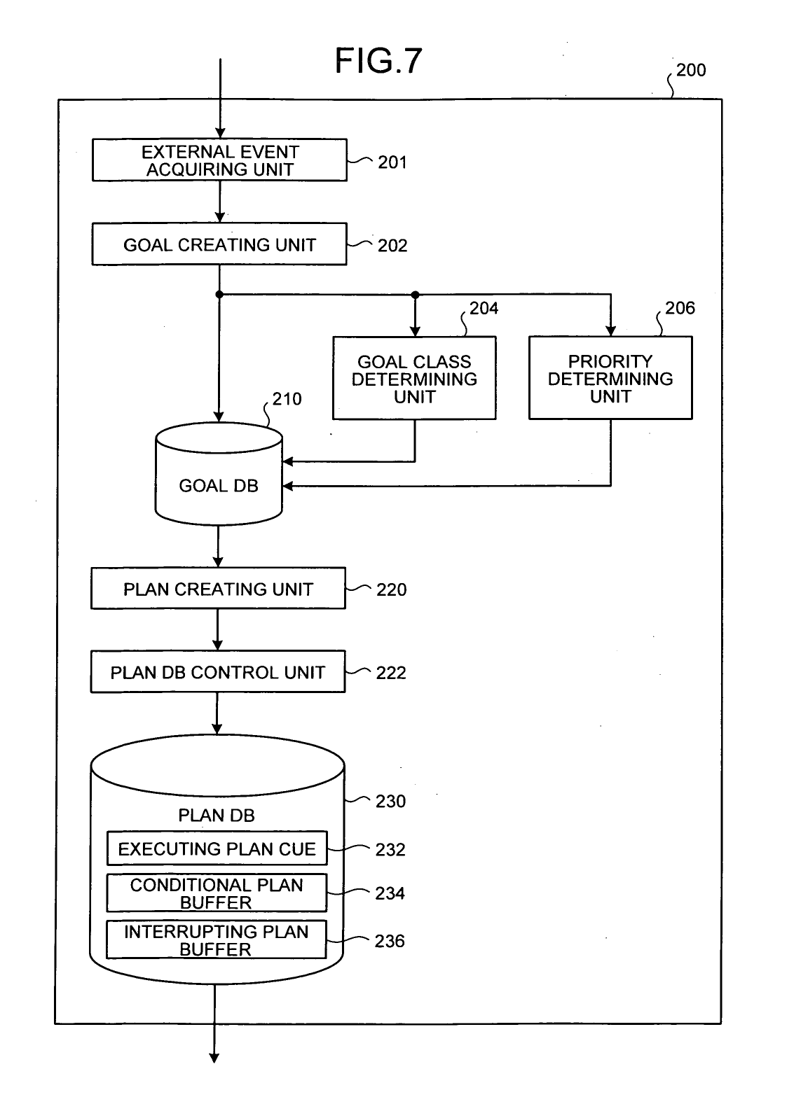

FIG. 7 is a block diagram showing the functional structure of a behavior planning unit 200. The behavior planning unit 200 has an external event acquiring unit 201, a goal creating unit 202, a goal class determining unit 204, a priority determining unit 206, a goal database (DB) 210, a plan creating unit 220, a plan DB control unit 222, and a plan DB 230.

The external event acquiring unit 201 acquires an external event from the external world monitoring unit 100. The goal creating unit 202 creates a goal based on an external event acquired by the external event acquiring unit 201 while referring to the information held by the knowledge DB 400.

For example, when the external event acquiring unit 201 acquires a speech recognition result, “bring me a newspaper,” as an external event, the goal creating unit 202 generates a goal for “bring a newspaper.” As such, the goal creating unit 202 creates a goal based on the keywords when the preset keywords are acquired by the speech recognition.

A rule for creating a goal from keywords acquired from a speech recognition result, i.e., goal generating information, is held in the knowledge DB 400. Specifically, the knowledge DB 400 holds a goal creating table making keywords correspond to a goal class. The goal creating unit 202, in the goal creating table held in the knowledge DB 400, extracts the goal corresponding to the keywords as a goal corresponding to an external event.

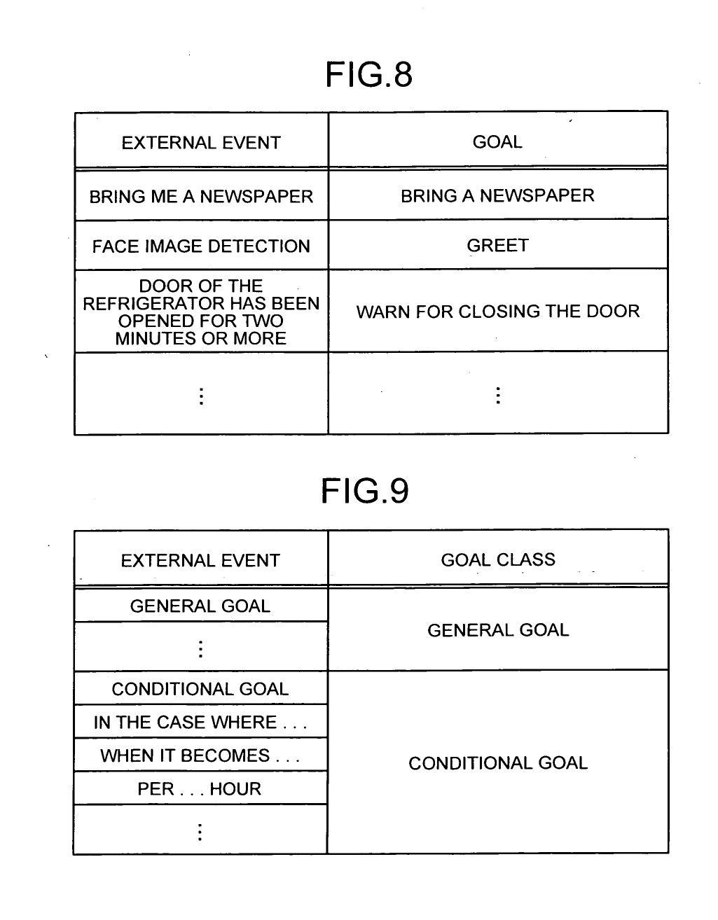

FIG. 8 is a diagram showing the data structure of a goal creating table. In the goal creating table, the external event of the speech recognition result of “bring me a newspaper” corresponds to the goal of “bring a newspaper.” Accordingly, the goal creating unit 202 creates the goal of “bring a newspaper” from the external event of speech recognition result of “bring me a newspaper” by referring to the goal creating table.

Also, when an external event is based on an image processing result, a goal is generated in correspondence to an image processing result. For example, when the information of a face image detection is acquired as an external event, a goal of “greet” is generated as referring to the goal creating table shown in FIG. 8.

When a network event from a refrigerator occurs, and the door of the refrigerator has been opened for two or more minutes, a goal of “warn for closing the door” is created as referring to the goal creating table shown in FIG. 8.

When network device condition information, which indicates that freshness date of a particular food is approaching, is acquired as an external event, a goal of “warn to tell that freshness date is approaching” is generated. Regarding other network home appliances such as an air conditioner, a light, and so on, a goal is also generated based on an external event of the network device condition information.

As another example, the goal creating unit 202 may create one goal based on plural external events. The goal creating unit 202 may generate plural goals based on one external event.

Here, as another example, the knowledge DB 400 may holds an algorithm for creating a goal from keywords instead of the goal creating table. In this situation, the goal creating unit 202 determines a goal from the keywords based on the algorithm.

The knowledge DB 400 may be referred to as a goal information generating information holding unit. Also, the algorithm for generating the goal from the keywords according to this embodiment is, in other words, goal generating information.

The goal class determining unit 204 determines a goal class of the goal generated by the goal creating unit 202 based on the event acquired by the external event acquiring unit 201. Here, a goal class can be a general goal class or a conditional goal class.

The general goal is a goal class whose goal is achieved by the process to be executed in the order that is acquired by the external event acquiring unit 201. Examples of the general goal are “find grandma” and “bring me a newspaper.”

The conditional goal class is the goal class whose goal is achieved by the process to be executed only when a preset executing condition is satisfied regardless of the order acquired by the external event acquiring unit 201. The goal class determining unit 204 further determines the executing condition relative to the conditional goal.

A process to be executed by a mobile robot may be a process with different degrees of urgency. For example, a process may be the one that does not require an immediate attention but is preferably executed if it is executable during a general process. For another example, a process may be the one if a particular condition, such as executing the process at 3 o'clock, is met, any other executing processes should be stopped and interrupted by executing that process. These processes can be treated as conditional goals.

A conditional goal may be the one which is executable when a general event such as “greet when meeting a person” and “if any shining object is found, pick it up” occurs. Also, a conditional goal may be the one which is executable when a time event or a periodic event such as “give snacks at 3 o'clock” and “tell me time every 1 hour” occurs. The conditional goal is the goal that is executable on the condition that a certain event occurs.

A goal class determining unit 204 determines a goal class of a goal as “general goal” relative to the external event when a keyword indicating “general goal” is detected as an external event together with a speech recognition result. When keywords such as “in the case where . . . ” is included in a speech recognition result, the goal class is determined to be “conditional goal.” As such, when the goal class determining unit 204 acquires some of the preset keywords, a goal class is determined based on the keywords.

Also, rules for specifying a goal class from keywords acquired from a speech recognition result is held in the knowledge DB 400. Specifically, the knowledge DB 400 holds the goal class generating table making the keyword corresponding to the goal class.

FIG. 9 is a diagram showing an example of the data structure of the goal class generating table. In the goal class generating table, the speech information of “general goal” is corresponding to the goal class, i.e., “general goal.” Therefore, the goal class determining unit 204 determines the goal class as “general goal” from the speech information of “general goal” by referring the goal class generating table.

Other than the above-description, a keyword such as “in the case where . . . ” is corresponding to a “conditional goal.” Therefore, even if the goal class determining unit 204 does not directly acquire a goal class as the speech information, a goal class may be determined based on the keyword.

Furthermore, the executing condition is specified based on the speech information just before the keyword such as “in the case where . . . ” Specifically, for example, when the speech recognition result of “in the case where a newspaper is found anywhere” is acquired as the external event, the goal class is specified as “conditional goal” and the executing condition is set to be “if the robot find a newspaper”.

As such, when the speech recognition result, “in the case where a newspaper is found anywhere, “bring me the newspaper” is acquired as an external event, the goal class is determined to be “conditional goal” and the executing condition is determined to be “if the robot find a newspaper.”

Also, as another example, the knowledge DB 400 may hold an algorithm to specify a goal class from the keywords. At that time, the goal class determining unit 204 specifies a goal class from the keywords based on the algorithm.

Here, the knowledge DB 400 may be referred to as a goal class generating information holding unit. Also, the algorithm to specify the goal class from the keywords according to the embodiment is, in other words, goal class generating information.

The priority determining unit 206 determines the priority of the goal created by the goal creating unit 202 based on the event acquired by the external event acquiring unit 201. Here, a priority is an index of preference in the order of the execution of the plan created relative to a goal regardless of the generating order of the plan. The higher the priority is set, the earlier the plan is placed in the executing order.

The priority determining unit 206, for example as the speech recognition result, when a keyword of “high priority” is detected, determines a priority as “high.” Furthermore, if keywords such as “posthaste” and “rush” as a speech recognition result, a priority is set “high”. For example, when a speech recognition result of “bring me a newspaper immediately” is acquired as an external event of a speech recognition result, a priority is set to be “high.”

As such, when a preset keyword is acquired from the speech recognition, the priority determining unit 206 determines a priority based on the keyword. Also, the rule specifying a priority from keywords acquired from a speech recognition result is held in the knowledge DB 400. Specifically, the knowledge DB 400 holds the priority table making the keywords correspond to the priorities.

Also, as another example, for example, when a speech recognition result of “bring me a newspaper” is repeatedly detected, a priority is considered high and may be determined as “high.” Furthermore, when no information regarding a priority can be acquired, the priority can be set in a default value, “middle.”

As another example, the knowledge DB 400 may hold an algorithm to specify a priority from a keyword. As such, the priority determination position 206 refers to an information of the knowledge DB 400 and determines a priority of a goal created by the goal creating unit 202.

Here, the knowledge DB 400 may be referred to as a priority determination information holding unit. Also, an algorithm for specifying a priority from a keyword according to the embodiment is, in other words, priority determination information.

Accordingly, for example, when a speech recognition result of “bring me a newspaper immediately” is acquired as an external event, the goal creating unit 202 generates the goal of “bring a newspaper.” Then, the goal class determining unit 204 determines the goal class of the generated goal as “general goal.” The priority determining unit 206 sets the priority of the goal “high.”

Also, if a speech recognition result of “bring a newspaper if you see it anywhere” is acquired as an external event, the goal creating unit 202 generates the goal of “bring a newspaper.” Then, the goal class determining unit 204 determines that the goal class of the generated goal is “conditional goal” and specifies the executing condition of “saw the newspaper.” Also, the priority determining unit 206 determines that the priority of goal is “middle” of the default value.

Also, as an example of the case where network device condition information is acquired as an external event, an external event indicating that a door of a refrigerator has been opened for two minutes or more is acquired. Furthermore, the external event, which indicates that the door of the refrigerator has been opened for two minutes or more, corresponds to “high” priority of a goal together with the goal. In this situation, the goal creating unit 202 creates a goal of “warn for closing the door.” Then, the goal class determining unit 204 determines a goal class of the goal as “general goal.” The priority determining unit 206 determines that a priority of the goal is “high.”

Also, for the external event, which indicates that freshness date of foods in the refrigerator is approaching, the goal creating unit 202 creates a goal of “warn that the freshness date of the foods is approaching.” Then, the goal class determining unit 204 determines that a generated goal class of the goal is “general goal.” The priority determining unit 206 determines a priority of the goal “middle.” The goal DB 210 holds the goal created by the goal creating unit 202, the goal class determined by the goal class determining unit 204, and the priority determined by the priority determining unit 206.

The plan generating unit 220 creates plans from each of the general goal held by the goal DB 210 and the conditional goal held by the goal DB 210. The plan generated from the general goal is hereinafter referred to as a general plan. Also, the plan generated from the conditional goal is hereinafter referred to as a conditional plan. The plan DB control unit 222 holds the general plan and the conditional plan created by the plan creating unit 220 in the plan DB 230 and controls the executing order thereof. Here, the plan DB control unit 222 may be referred to as an executing order determining unit.

The plan DB 230 has an executing plan cue 232, a conditional plan buffer 234, and an interrupting plan buffer 236. The executing plan cue 232 holds the executing plan and the conditional plan created by the plan creating unit 220 in the executing order of the plan executing unit 300. That is, according to the order held by the executing plan cue 232, plural plan are executed in the order. The conditional plan buffer 234 holds the conditional plan created by the plan creating unit 220. The interrupting buffer 236 holds the plan interrupted during the execution of the plan.

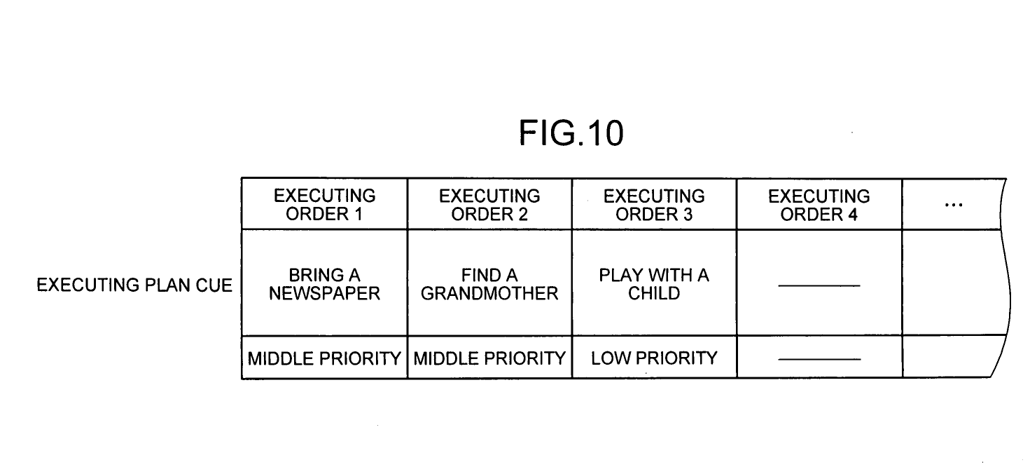

FIG. 10 is a diagram showing an example of data structure of the executing plan cue 232. The executing plan cue 232 shown in FIG. 7 stores plans, i.e., “bring a newspaper,” “find a grandmother,” and “play with a child” in the order of the executing order number 1, the executing order number 2, and the executing order number 3, respectively. Accordingly, the plans are executed in this order.

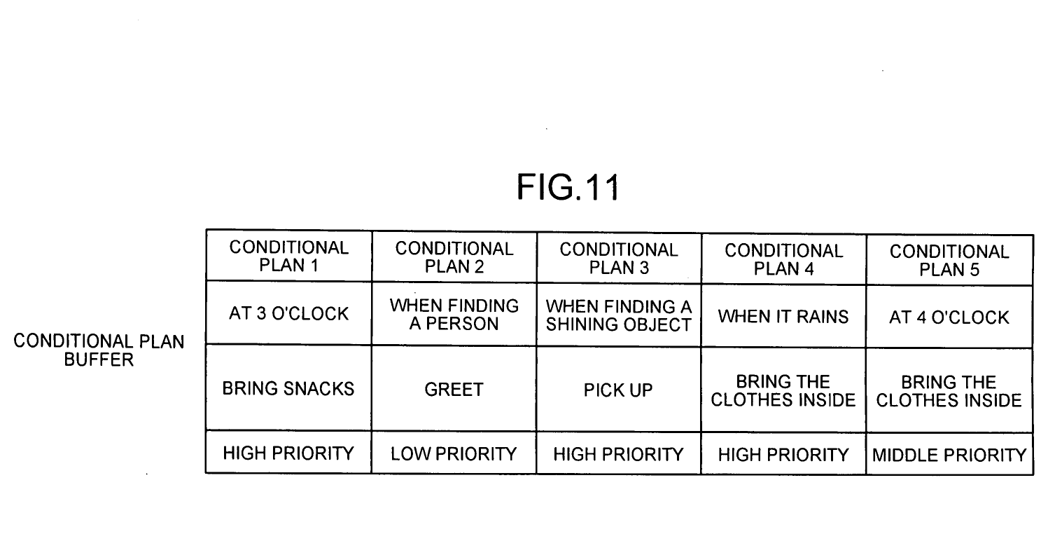

FIG. 11 is a diagram showing an example of data structure of the conditional plan buffer 234. The conditional plan buffer 234 may hold one conditional plan or two or more conditional plans.

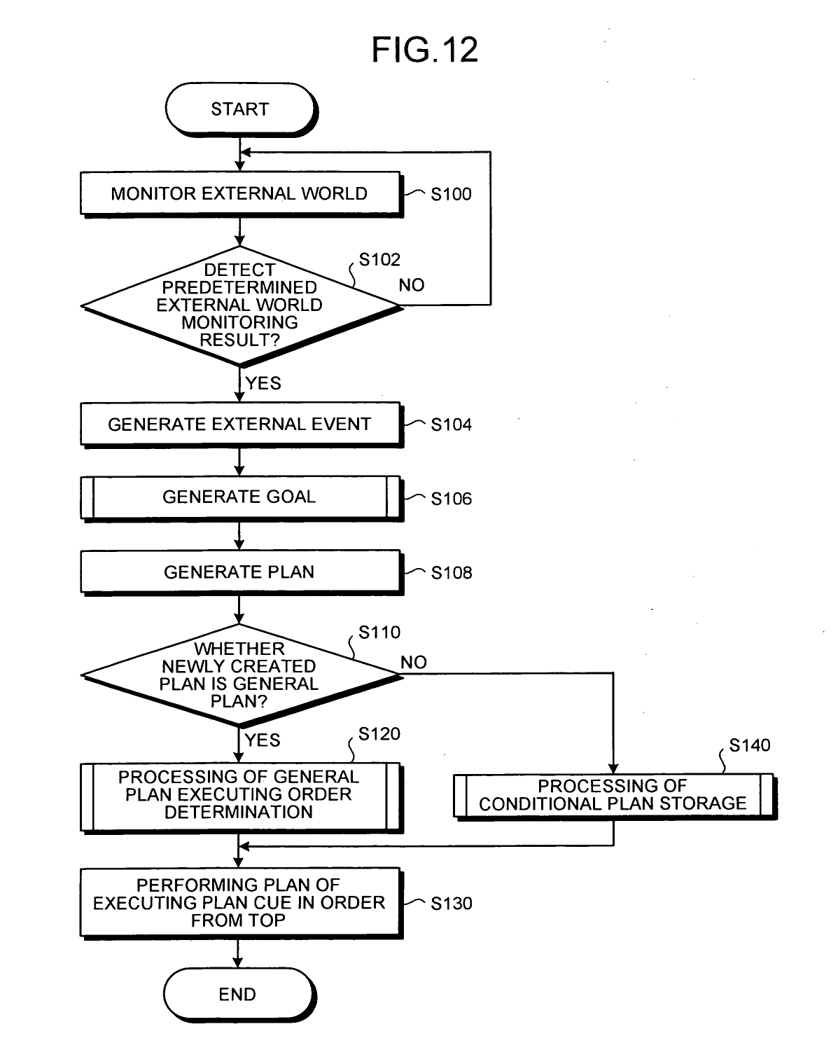

FIG. 12 is a flowchart showing an action plan process by the mobile robot 1. The external world monitoring unit 100 of the mobile robot 1 constantly monitors the speech order, sensor input such as an image, event input from the network appliances (Step S100). Then, if the preset outside monitoring result is acquired (Yes at Step S102), the external event generating unit 130 of the external world monitoring unit 100 generates the external event based on the external monitoring result.

Specifically, whether the speech is detected by the sensor input is examined. If the speech is detected, whether there is the registered speech information or not is examined. Then, whether there is pre-registered image such as a face image or not is examined. Then, whether there is the network device events information connected with the network or not is examined.

When the registered speech information, the registered image, and the registered event information are acquired, the external event generating unit 130 generates the corresponding external events. When the registered outside monitoring result is not acquired (No at Step S102), the external world monitoring unit 100 constantly monitors the outside (Step S100).

Next, the behavior plan unit 200 creates the general goal or the conditional goal based on the external event generated by the external world monitoring unit 100 (Step S106). Then, the plan is created in order to achieve the generated goal (Step S108).

When the plan class of the created plan is the general plan (Yes at Step S110), the plan DB control unit 222 determines the executing order of the general plan and stores in the executing plan cue 232 of the plan DB 230. At this time, in the executing plan cue 232, it is stored in the order corresponding to the position in the executing order (Step S120). Next, the plan executing unit 300 executes the plans in the order of the plans stored from the top of the executing plan cue 232 (Step S130).

When the plan class created at Step S110 is conditional (No at Step S110), the plan DB control unit 222 stores this conditional plan in the interrupting plan buffer 236 of the plan DB 230. Then, when the executing condition of the conditional plan is satisfied, the conditional plan is to be stored in the predetermined position of the executing plan cue 232 to be executed (Step S140). Then, the plan is executed in the order from the plan stored at the top of the executing plan cue 232 (Step S130). Then, the behavior planning process of the mobile robot 1 is completed.

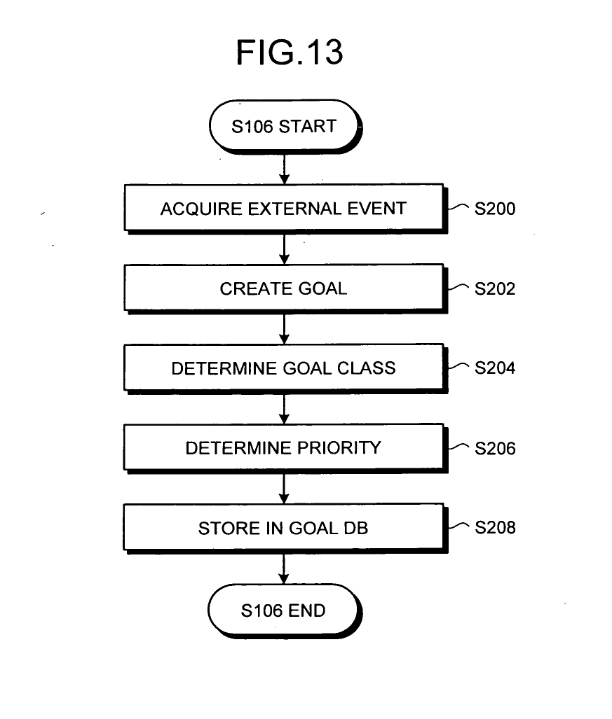

FIG. 13 is a flowchart showing the detailed process at the goal creating process (Step S106) explained in FIG. 12. The external event acquiring unit 201 of the behavior planning unit 200 acquires the external event from the external world monitoring unit 100 (Step S200). Next, the goal creating unit 202 creates the goal corresponding to the external event (Step S202). Further, the goal class determining unit 204 determines the goal class of the created goal (Step S204). Furthermore, the priority determining unit 206 determines the priority of the goal class of the created goal (S206). Then, the created goal, the goal class, and the priority are made to correspond each other to be stored in the goal DB 210 (Step S208).

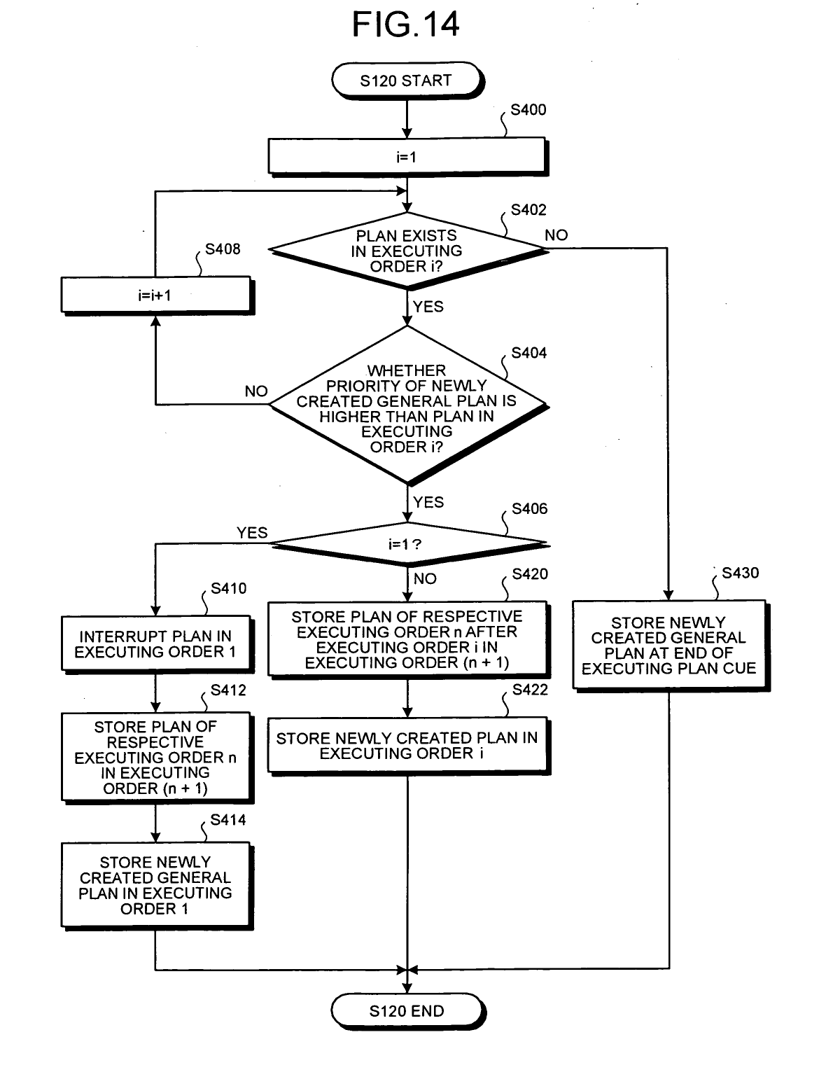

FIG. 14 is a flowchart showing the detailed process at the general plan executing order determination process (Step S120) explained in FIG. 12. Firstly, the plan DB control unit 222 sets the counter value “i” as 1 (Step S400). That is, the counter is reset. Next, if there is a plan of the execution plan cue 232 stored in the position of the executing order “i” (Yes at Step S402), the priority of the newly created plan is compared to the plan stored in the executing order “i.” Because “i” is set to be 1, specifically, the priority of the plan stored in the executing order 1 is compared with the priority of the newly created general plan.

If the priority of the newly created general plan is higher than the priority of the plan stored in the executing order “i” and the counter value “i” is one (1) (Yes at Step S404 and Step S406), the execution of the plan stored in the executing order 1 is interrupted, and the interrupted plan is stored in the interrupting buffer 236 (Step S410).

Furthermore, the plans stored in the executing order “n” are stored respectively in the executing order (n+1) (Step S412). Furthermore, the newly created general plan is stored in the executing order 1 (Step S414). As such, if the newly created plan is the plan to be executed prior to the currently executing plan, the executing plan is temporary interrupted and the newly created plan is stored at the top of the executing plan cue 232, i.e., the executing order 1.

On the other hand, if the counter value “i” is one (1) or more (No at Step S406), the plans stored in the respective executing order “n” after the executing order “I” are respectively stored in the executing order (n+1) (Step S420). Furthermore, the newly created general plan is stored in the executing order “i” (Step S422).

Also, in Step S404, if the priority of the newly created general plan is lower than the priority of the plan stored in the executing order “i” (No at Step S404), the value of “i” is increased by 1 (Step S408) and returns to Step S402.

In the Step S402, if the plan is not stored in the executing order “i” (No at Step S402), the newly created general plan is stored in the end of the executing plan cue 232 (Step S430). Here, the general plan executing order determination process (Step S120) is completed.

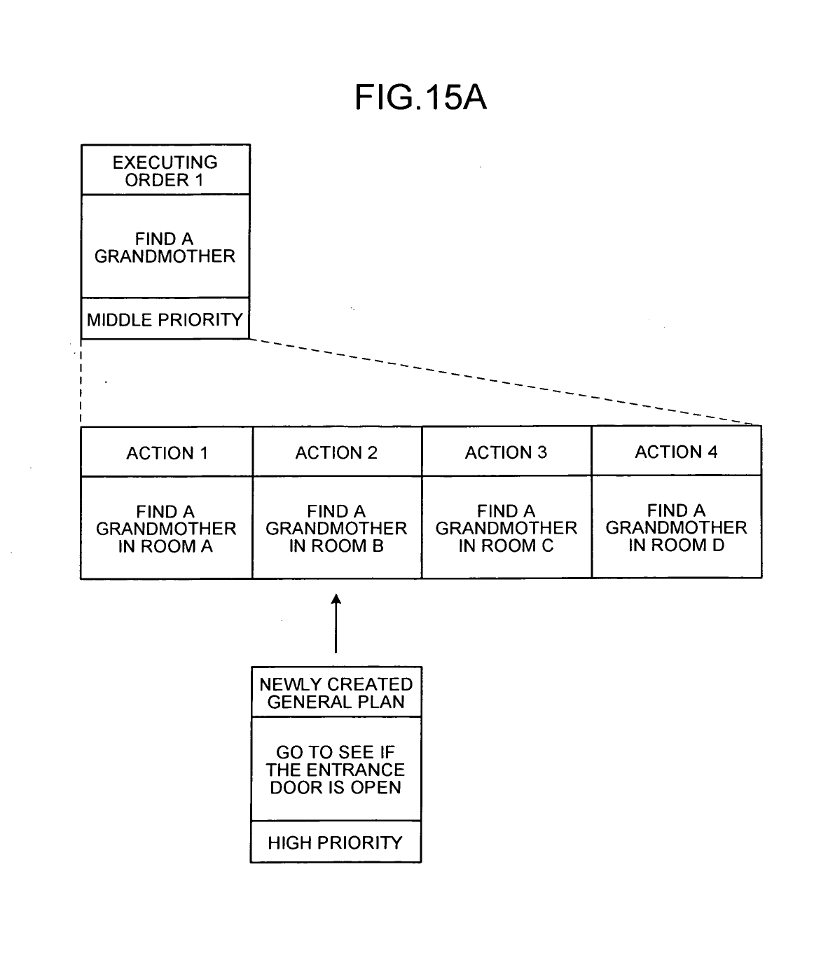

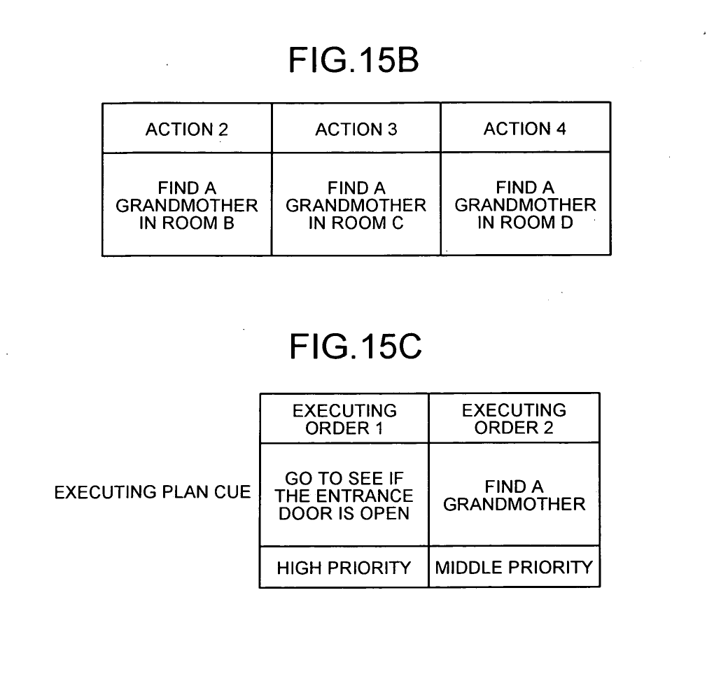

FIGS. 15A, 15B, and 15C are diagrams explaining in more detail a general plan executing order determination process when a priority of a newly created general plan is higher than a plan in the currently executing plan. As shown in FIG. 15A, a priority of a plan stored in the executing order 1, “find a grandmother” is middle and a priority of a newly created general plan, “go to see if the entrance door is open” is high.

The plan stored in the executing order 1 includes plural actions (action 1 to action 4), where the action 1 includes “find a grandmother in the room A,” the action 2 includes “find a grandmother in the room B,” the action 3 includes “find a grandmother in the room C,” and the action 4 includes “find a grandmother in the room D.”

Among these actions, it is assumed that a newly created general plan is added while executing the action 2, “find a grandmother in the room B.” In this case, the plan of the executing order 1, “find a grandmother” is interrupted. Then, as shown in FIG. 15B, three actions, i.e., the actions 2 to 4, to be executed after the action 2 of “find a grandmother in the room B” which is being executed are held in the interrupting plan buffer 236.

Also, as shown in FIG. 15C, the newly created general plan is stored in the executing order 1 of the executing plan cue 232. The plan, “find a grandmother” is stored in the executing order 2. Then, when executing the plan to be stored in the executing order 2, i.e., once interrupted plan, the actions 2 to 4 stored in the interrupting plan buffer 236 are executed.

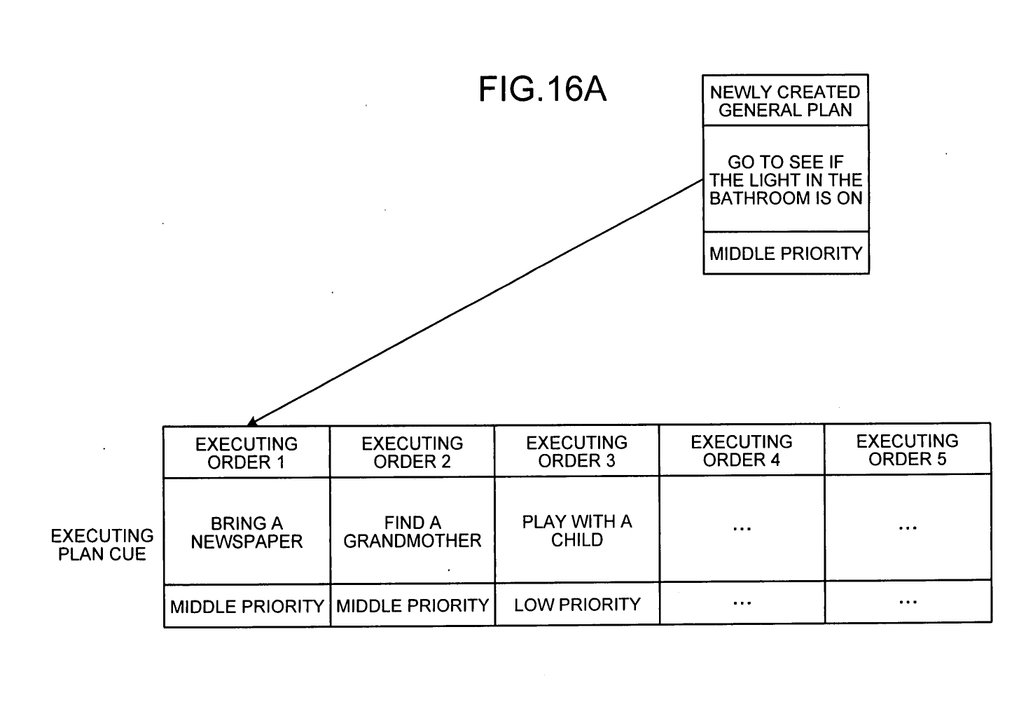

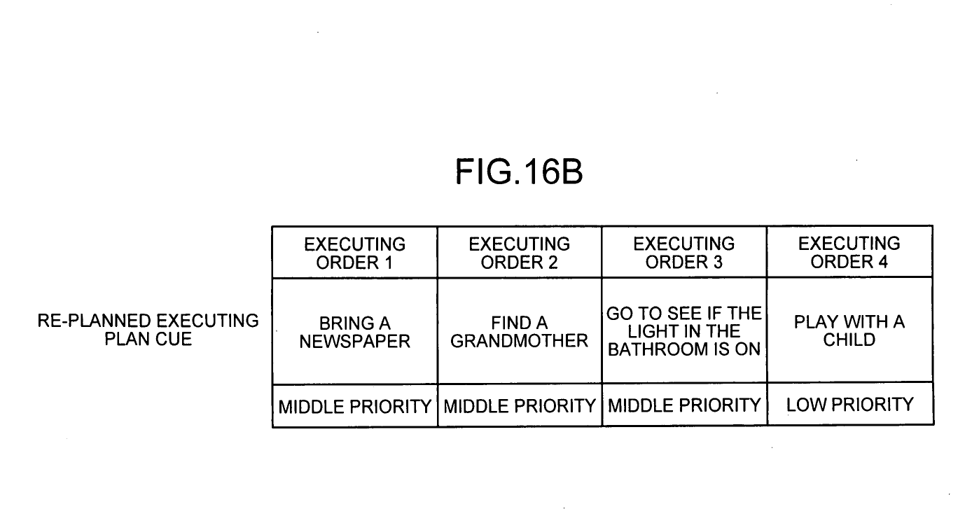

FIGS. 16A and 16B are diagrams explaining the process when the general plan is newly created. FIG. 16A is a diagram explaining the process when a general plan is newly created. As shown in FIG. 16A, it is assumed that the general plan with the middle priority is newly created. It is also assumed that plans are stored in the executing orders 1 to 3 of the executing plan cue 232.

At this time, the priority of the newly created general plan is compared to the priority of the plans stored in the executing orders 1 to 3 in order. The priority of the newly created general plan is higher than the priority of the plan stored in the executing order 3 and therefore is to be stored prior to the executing plan 3. Accordingly, as shown in FIG. 16B, the newly created general plan is stored in the executing order 3. Then, the plan already stored in the executing order 3 at the time of storing the newly generated plan would be stored in the executing order 4.

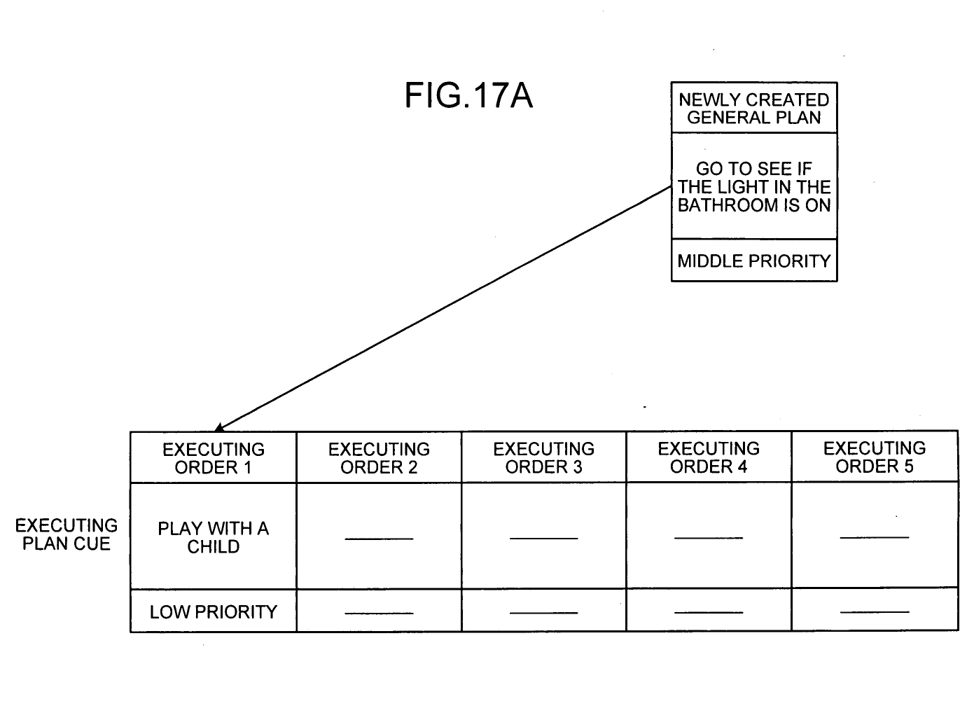

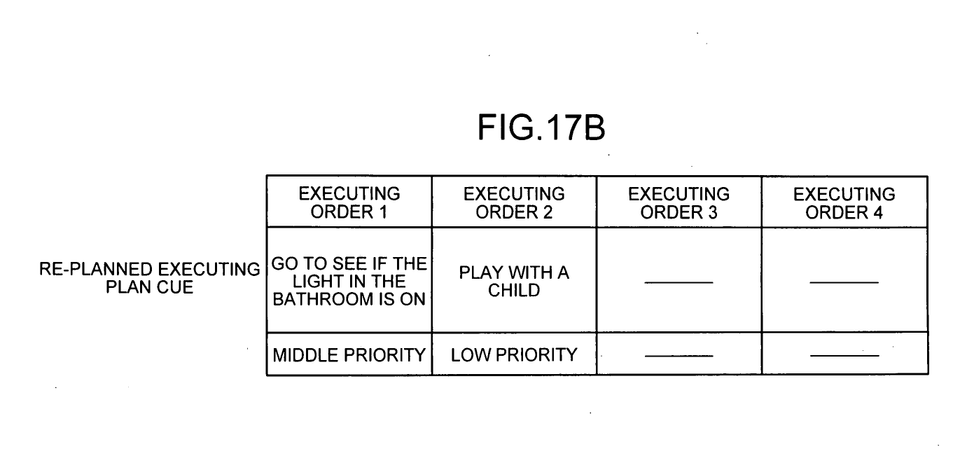

FIGS. 17A and 17B are diagrams explaining the process when executing a newly created general plan as interrupting an executing plan. As shown in FIG. 17A, it is assumed that a general plan with middle priority is created. It is also assumed as shown in FIG. 17A that a plan with low priority is stored in the executing order 1 of the executing plan cue 232.

In this situation, the priority of the newly created general plan is higher than the priority of the plan stored in the executing order 1. Therefore, the plan stored in the executing order 1 is interrupted and the interrupted plan is stored in the temporary interrupted plan buffer 236. Then, the newly created general plan is stored in the executing order 1.

Furthermore, the interrupted plan is stored in the executing order 2 so as to execute the newly created general plan next. As such, as shown in FIG. 17B, the newly created general plan is stored in the executing plan 1.

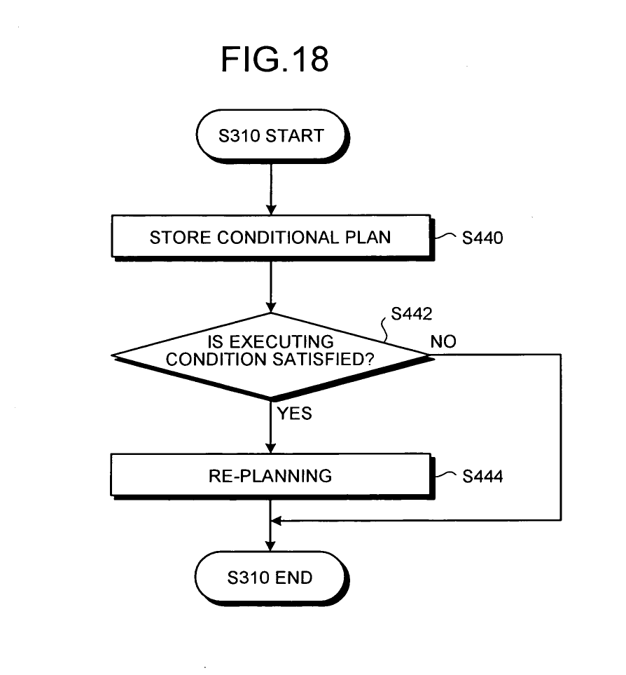

FIG. 18 is a flowchart showing the detailed process at the conditional plan storing process (Step S140) explained in FIG. 12. In the conditional plan storing process, the plan DB control unit 222 stores the newly created conditional plan in the conditional plan buffer 234 (Step S440).

Next, the plan DB control unit 222 determines whether the condition for the execution of the conditional plan stored in the conditional plan buffer 234 is satisfied or not. When the condition for the execution is satisfied (Yes at Step S442), this conditional plan is stored in the position of the executing order, which satisfies the condition for the execution, in the executing plan cue 232 (Step S444). Accordingly, the conditional plan storing process (Step S140) is completed.

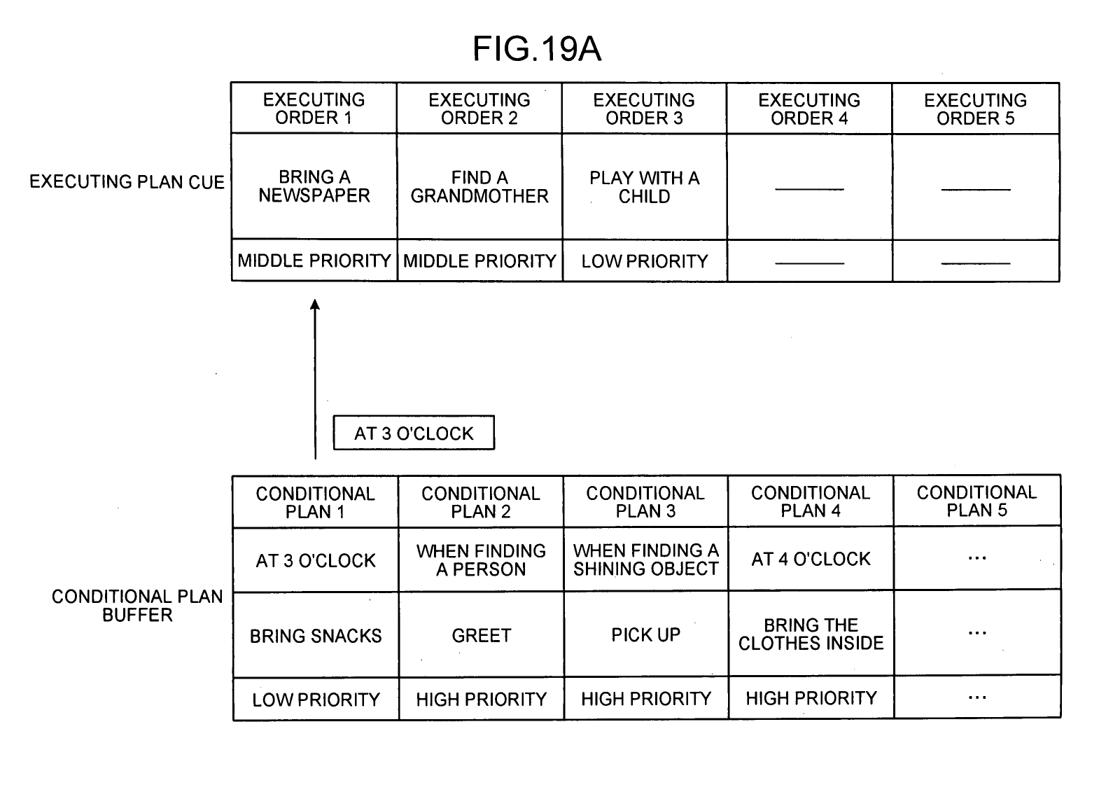

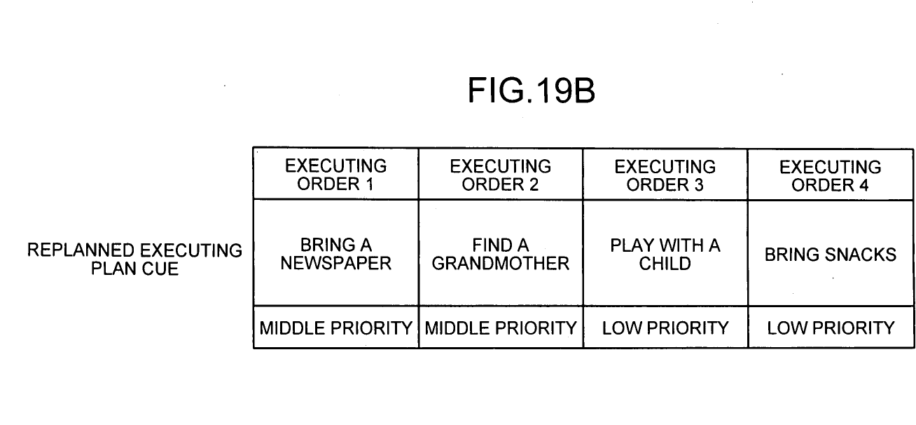

FIGS. 19A and 19B are diagrams explaining the process when an executing condition of an conditional plan stored in the conditional plan buffer 234 is satisfied. As shown in FIG. 19A, when three plans are stored in the executing plan cue 232, it is assumed to be 3 o'clock. At that time, among the conditional plan stored in the conditional plan buffer 234, the executing condition of the conditional plan, “bring snacks” is satisfied. Here, the plan DB control unit 222 stores the conditional plan in the executing plan cue 232.

Because the priority of the conditional plan, “bring snacks” is low, as shown in FIG. 19B, the conditional plan is stored in the next position to the plan, “play with children,” with low priority already stored in the executing plan cue 232, i.e., executing order 4.

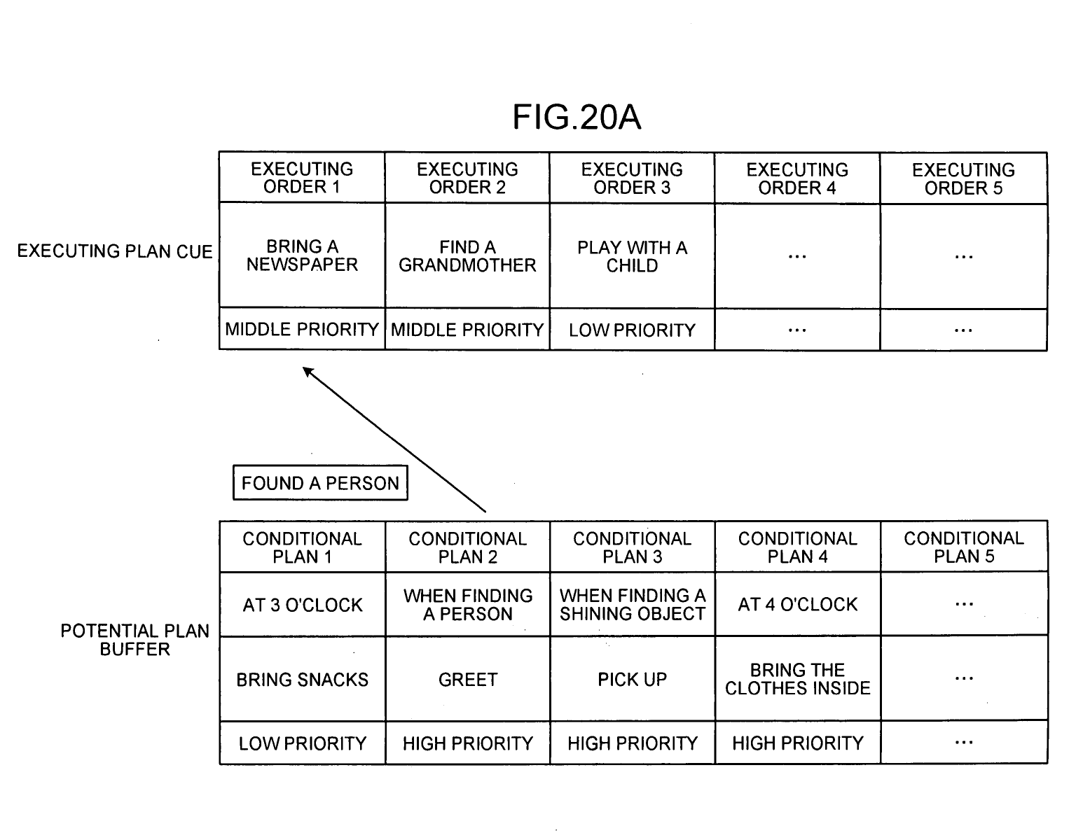

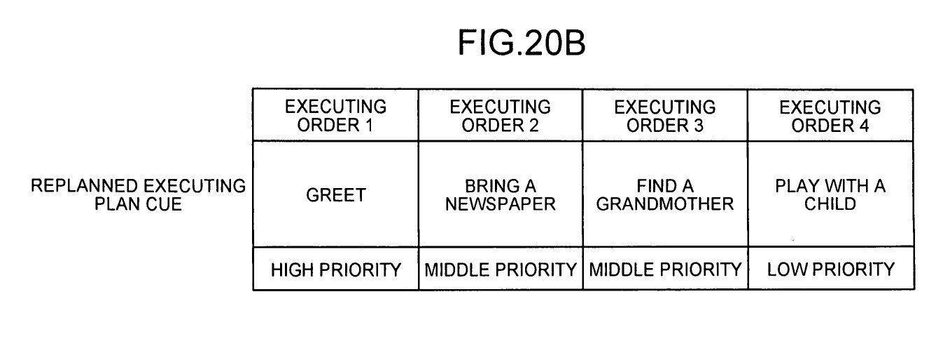

FIG. 20A and 20B are diagrams explaining the process when executing a conditional plan stored in the conditional plan buffer 234 prior to a plan already stored in the executing plan cue 232. As shown in FIG. 20A, it is assumed that a person is found when three plans are stored in the executing plan cue 232. In this situation, the condition for the execution of the conditional plan, “greet” in the conditional plans that are stored in the conditional plan buffer 234 is satisfied. Here, the plan DB control position 222 stores this conditional plan in the executing plan cue 232.

The priority of the conditional plan, “greet” is high and is higher than the priority of the plan stored in the executing order 1 of the executing plan cue 232. Therefore, as shown in FIG. 20B, the conditional plan is stored in the executing order 1 of the executing plan cue 232. Then, the plan stored in the executing order “n” prior to the storage of the conditional plan is respectively stored in the executing order (n+1).

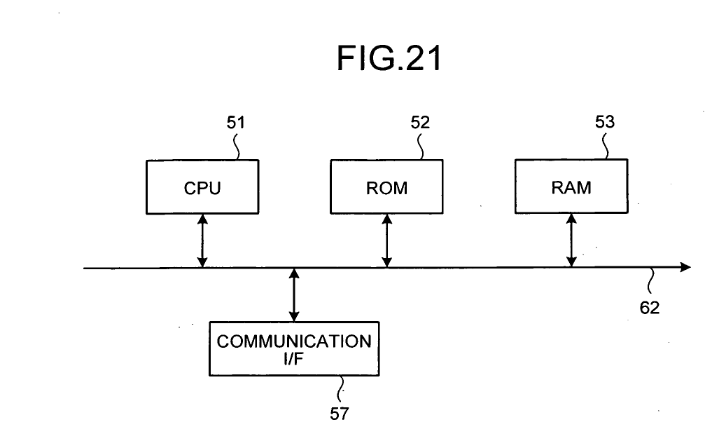

FIG. 21 is a diagram showing the hardware structure of the mobile robot 1 according to the first embodiment. The mobile robot 1, as its hardware structure, comprises a ROM 52 storing such as behavior plan program executing behavior plan process in the mobile robot 1, a CPU 51 controlling each unit of the mobile robot 1 according to the program in the ROM 52, a RAM 53 recording various data necessary for control of the external world monitoring unit 100, communication I/F 57 connected with the network to communicate, and bus 62 connecting each unit.

The above-described behavior plan program in the mobile robot 1 may be recorded and provided in a computer readable recoding medium such as a CD-ROM, a floppy (registered trademark) disk (FD), and a DVD in an installable format or executable format file.

At this time, the behavior plan program is loaded on a main memory unit by reading from the above-described recoding medium in the mobile robot 1, and each unit explained in the above software structure is generated on the main memory unit.

Also, the behavior planning program of this embodiment may be stored in a computer connected to the network such as the Internet and may be provided by downloading through the network.

The embodiments of this invention were explained above but various modifications and changes to the above embodiments may be added.

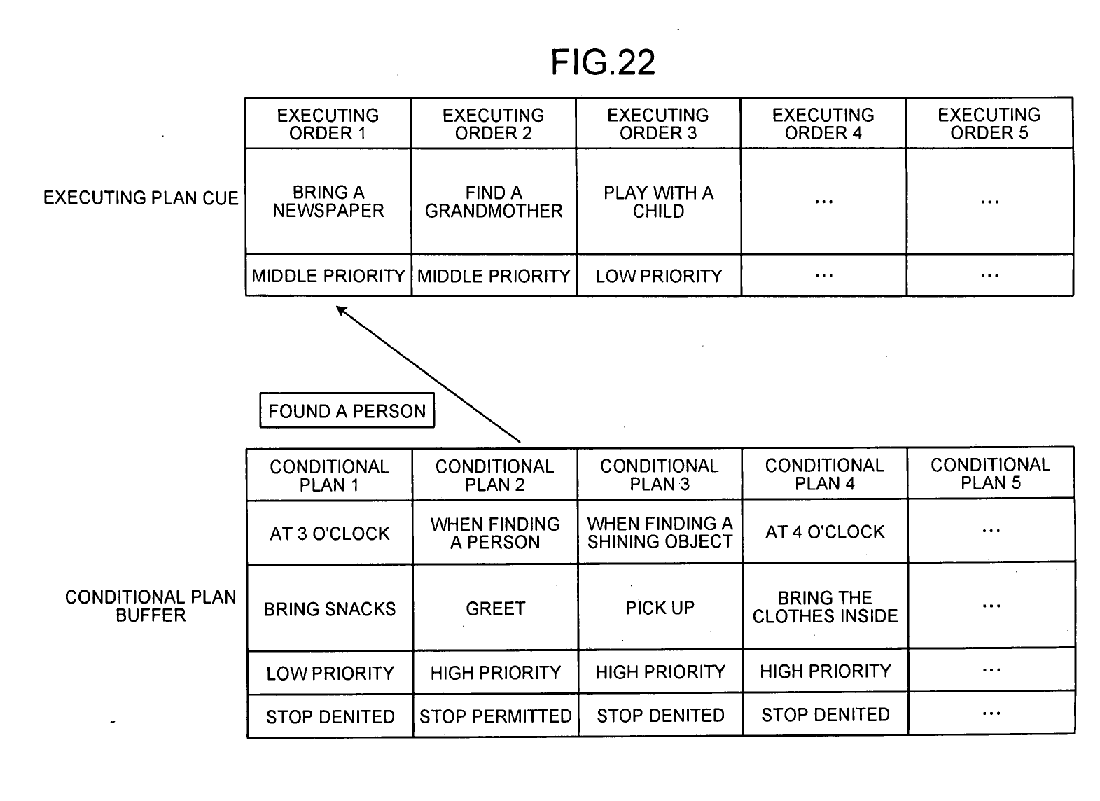

FIG. 22 is a diagram explaining the first modification. A first modification of the embodiments for the behavior planning unit 200 of the mobile robot 1 may further comprise a permission/denial information generating unit (not shown in the figures). The permission/denial information generating unit generates the permission/denial information for not determining the executing order based on the condition for the execution relative to the conditional plan.

As shown in FIG. 22, the permission/denial information indicating to permit/deny the determination of the executing order is further provided in addition to the priority. Here, the permission/denial information, when complying/satisfying with the executing condition of the conditional plan, has the information that must determine the predetermined executing order, i.e., the information indicating that the execution is necessary. Also, there is information that the executing order does not have to be decided even if the condition of the execution of the conditional plan is satisfied, i.e., information that does not need to be executed.

Specifically, the conditional plan with permission/denial information indicating that the interruption/stop is not permitted, similar to the above-explained embodiments, when satisfying the condition for the execution, is stored in a proper executing order. Then, it is executed in order according to the executing order.

On the other hand, the conditional plan having the permission/denial information indicating to permit the stop, when stored other than in the executing order 1, is stopped from being in the executing plan cue. For example, the permission/denial information for permitting to stop is assigned, when satisfying the condition, to the conditional plan, indicating that it is preferable not to execute if the immediate execution is preferred but the immediate execution is not possible.

For example, it is assumed that an executing condition, “if a person is found” of a conditional plan, “greet” as shown in FIG. 22 is satisfied. Here, in this embodiment, a priority of the plan, “bring a newspaper”, stored in the executing order 1 is high, and therefore the conditional plan, “greeting” is stored next to the plan, “bring a newspaper”, i.e., the executing order 2. However, greeting after bringing a newspaper is too late, and therefore it is appropriate not to greet in that situation.

In that situation, the permission/denial information regarding the stop permission is supplied to the conditional plan, “greet.” As such, if the conditional plan, “greet” is not positioned in the executing plan cue when assigning the executing order after the plan, “bring a newspaper.”

Accordingly, by assigning the permission/denial information indicating permission/denial for stopping to introduce in the executing plan cue relative to the conditional plan, the conditional plan can be executed with more appropriate timing.

Also, the permission/denial information generating unit generates the permission/denial information based on the keyword involved in the executing condition. For example, when the keywords such as “if it passes . . . o'clock” and “if it becomes . . . ” are detected, the permission/denial information indicating to deny the stop denial is generated. Also, in the other situation, the permission/denial information indicating to permit the stop permission is generated. Specifically, the knowledge DB 400 further has a permission/denial information generating table making the keywords correspond to the permission/denial information, and the permission/denial information generating unit generates the permission/denial information by utilizing the permission/denial information generating table.

Also, as another example, the knowledge DB 400 may holds an algorithm for creating the permission/denial information from the keywords instead of the permission/denial information generating table. In this case, the goal creating unit 202 determines the goal from the keywords based on the algorithm.

Here, the knowledge DB 400 may be referred to as a permission/denial information generating information holding unit. Also, the algorithm for generating the permission/denial information from the keywords is, in other words, permission/denial information generating information.

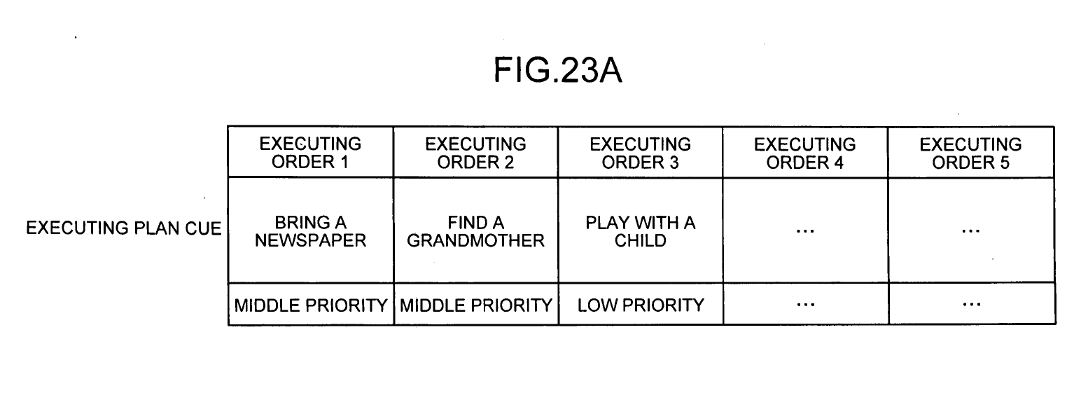

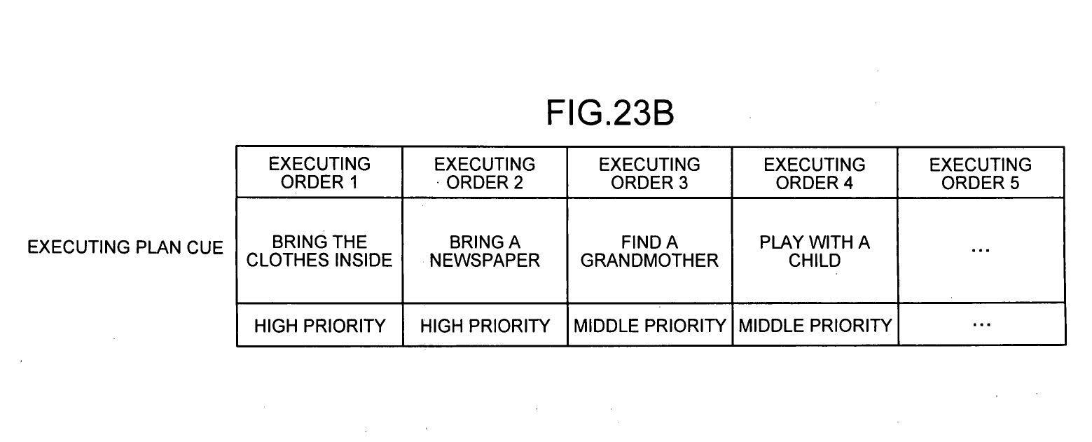

FIGS. 23A and 23B are diagrams explaining the second modification. In this example, priorities of the plans stored in the executing plan cue 232 is higher as the time passes upon being stored in the executing plan cue 232.

For example, as shown in FIG. 23A, it is assumed that a plan, “play with children” with low priority is stored in the executing plan cue 232. At this time, if the priority of plans stored in the executing plan cue 232 after “play with children” are middle priority or higher, then the plan, “play with children,” cannot be executed.

In order to resolve this problem, when the plan DB control unit 222 passes the preset time, the priority of the value is changed to be in a higher value. Specifically, relative to each plan, the time information indicating the time when the plan is introduced in the executing plan cue 232 is introduced. Then, when the time passes the preset time, the priority is changed to be higher. For example, the plan with the low priority is changed to have the middle priority. The plan with the middle priority is changed to have the high priority. Also, the plan with the high priority is not changed with respect to the priority.

As such, by changing the priority to be higher as time passes from the time stored in the executing plan cue 232, the plan with the low priority may be executed at the appropriate timing.

For example, a plan with the low priority stored in the executing order 3 as shown in FIG. 23A, as time passes, the priority is changed to the middle priority as shown in FIG. 23B. Also, a plan with the middle priority stored in the executing order 1 as shown in FIG. 23A, as time passes, the priority is changed to the high priority as shown in FIG. 23B. Here, the plan DB control unit 222 may be divided in an elapsed time counting unit and a priority adjustment unit.

Also, as a third modification, after creating the plans from each goal in this embodiment, the executing order of each plan is decided; however, instead of this, the executing order of each goal may be determined first. In this case, after the executing order is determined, the plan corresponding to the goal sequence arranged in the executing order.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A behavior control apparatus comprising:
an external condition acquiring unit configured to acquire an external condition of a mobile robot;
a goal generating unit configured to generate a goal to be achieved by executing a plan for multiple functions of the mobile robot, based on the external condition;
a goal class generating unit configured to generate a goal class indicating whether the goal is a general goal to be achieved in the order of generation of the goal or a conditional goal to be achieved by an interruption as satisfying a preset executing condition;
an executing order determining unit configured to determine an executing order of the plan based on the goal class; and
a plan generating unit configured to generate the plan for achieving a goal sequence of the order of execution.

2. The behavior control apparatus according to claim 1,
wherein the executing order determining unit re-determines, when the condition of the conditional goal is satisfied, the executing order for the conditional goal after satisfying the condition and the general goal.

3. The behavior control apparatus according to claim 1, further comprising
a goal creating information holding unit configured to hold goal creating information to be used for generation of the goal from the external condition,
wherein the goal creating unit uses the goal creating information held to create the goal.

4. The behavior control apparatus according to claim 1, further comprising
a speech recognizing unit configured to perform speech recognition of external speech,
wherein the external condition acquiring unit acquires a result of the recognition by the speech recognizing unit as the external condition, and
the goal generating unit generates the goal based on the result of the recognition acquired by the external condition acquiring unit.

5. The behavior control apparatus according to claim 1, further comprising
an image detecting unit configured to detect a surrounding image,
wherein the external condition acquiring unit acquires the image as the external condition, and
the goal generating unit generates the goal based on the image acquired by the external condition acquiring unit.

6. The behavior control apparatus according to claim 1,
wherein the external condition acquiring unit acquires, via a network, network device condition information indicating a condition of other device connected to the network, and
the goal generating unit generates the goal based on the network device condition information.

7. The behavior control apparatus according to claim 1, wherein the goal class generating unit generates the goal class based on the external condition.

8. The behavior control apparatus according to claim 7, further comprising
a goal class generating information holding unit configured to hold goal class generating information to be used for generation of the goal class from the external condition,
wherein the goal class generating unit uses the goal class generating information to generate the goal class.

9. The behavior control apparatus according to claim 1, wherein the executing order determining unit determines the executing order of the plan generated for the general goal, based on the order of generation of the general goal.

10. The behavior control apparatus according to claim 1, wherein the executing order determining unit determines the executing order of the plan generated for the conditional goal, based on the executing condition of the conditional goal.

11. The behavior control apparatus according to claim 10, wherein the executing condition of the conditional goal is a condition relating to the external condition.

12. The behavior control apparatus according to claim 10, further comprising
an executing condition generating unit configured to generate the executing condition of the conditional goal based on the external condition when the goal generated by the goal generating unit is the conditional goal,
wherein the executing order determining unit determines the executing order of the plan generated for the conditional goal, based on the executing condition.

13. The behavior control apparatus according to claim 1, further comprising
a priority determining unit configured to determine a priority for executing the goal generated by the goal generating unit,
wherein the executing order determining unit determines the executing order so as to achieve the goal in the order of the priority.

14. The behavior control apparatus according to claim 13, further comprising
a priority determination information holding unit configured to hold a priority determination information used when the priority is determined with the external condition,
wherein the priority determining unit determines the priority using the priority determination information.

15. The behavior control apparatus according to claim 13, wherein the executing order determining unit determines the executing order such that the plan generated for the conditional goal, when the executing condition of the conditional goal is satisfied and the priority of the conditional goal is higher than the priority of the general goal generated prior to the conditional goal, is executed prior to the plan generated for the general goal generated prior to the conditional goal.

16. The behavior control apparatus according to claim 13, further comprising
a permission/denial information generating unit configured to generate permission/denial information indicating a permission or denial for not determining the executing order of the plain generated for the conditional goal,
wherein the executing order determining unit, based on the executing condition, determines the executing order after the plan generated for the goal executing, for the plan generated for the conditional goal, and does not execute the plan generated for the conditional goal when the permission/denial information generating unit generates the permission/denial information indicating the permission for not determining the executing order for the plain generated for the conditional goal.

17. The behavior control apparatus according to claim 16, wherein the permission/denial information generating unit generates the permission/denial information based on the executing condition.

18. The behavior control apparatus according to claim 16, further comprising
a permission/denial information generating information holding unit configured to hold the permission/denial information generating information to be used when the permission/denial information is generated from the executing condition, and
the permission/denial information generating unit generates the permission/denial information based on the permission/denial information generating information.

19. The behavior control apparatus according to claim 13, further comprising
a lapsed time counting unit configured to count time lapsed from a timing when the executing order determining unit determines the executing order for the plan, and
a priority adjustment unit configured to change the priority determined for the plan to be higher when the lapsed time counting unit counts up to a preset time,
wherein the executing order determining unit updates the executing order of the plain based on the changed priority.

20. A behavior control method comprising:
acquiring an external condition of a mobile robot;
generating a goal to be achieved by executing a plan for multiple functions of the mobile robot, based on the external condition;
generating a goal class indicating whether the goal is a general goal to be achieved in the order of generation of the goal or a conditional goal to be achieved by an interruption as satisfying a preset executing condition;
generating the plan for achieving a goal sequence of the order of execution; and
determining an executing order of the plan based on the goal class.

21. A computer program product having a computer readable medium including programmed instructions for controlling a plan for multiple functions of a mobile robot, wherein the instructions, when executed by a computer, cause the computer to perform:
acquiring an external condition of the mobile robot;
generating a goal to be achieved by executing the plan, based on the external condition;
generating a goal class indicating whether the goal is a general goal to be achieved in the order of generation of the goal or a conditional goal to be achieved by an interruption as satisfying a preset executing condition;
generating the plan for achieving a goal sequence of the order of execution; and
determining an executing order of the plan based on the goal class.
